(19) United States
(12) Patent Application Publication
(10) Pub. No.: US 2011/0122878 A1
(43) Pub. Date: May 26, 2011

(54) METHOD OF PERCOLATION NETWORKING ARCHITECTURE FOR DATA TRANSMISSION AND ROUTING

(76) Inventors: Xiangming Li, Beijing (CN); Jihua Lu, Beijing (CN); Jianping An, Beijing (CN); Jie Yang, Beijing (CN)

(21) Appl. No.: 13/015,044

(22) Filed: Jan. 27, 2011

(51) Int. Cl. H04L 12/56

(52) U.S. Cl. 370/400

(57) ABSTRACT

The present invention relates to a new network architecture and its data transmission method based on percolation. The disclosed network architecture is a server-free and router-free network structure, wherein efficient routing can be operated with percolations based on the six degrees of separation theory in small world network modeling. An information transmission will be divided into two phases: routing phase and data transmission phase. In the routing phase, probe packets will be transmitted and forwarded in the network thus path selections are performed based on small-world strategy. In the second phase, the information will be encoded and transmitted using the paths selected at the first phase. In such a way, an efficient routing and data transmission mechanism can be built which allow us to construct a low-cost, flexible and ubiquitous network.

### BACKGROUND OF THE INVENTION

1. Field of the Invention

The present invention relates to a new network architecture and its data transmission and routing method based on percolation. Specifically, the invention relates to a server-free, router-free network structure in which efficient routing can be operated with percolations based on the six degrees of separation theory in small world network modeling. The present invention belongs to networking and data transmission technology field.

2. Description of the Related Art

There are large number of servers installed in existing network and large amount of routers relied on their corresponding servers. Once the servers are controlled by unauthorized party, their data security is threatened. The destruction of servers will cause the interrupt of communications. If we utilize this kind of traditional networking and routing method which relies on server, the data security and reliability is difficult to ensure. In fact, there are a lot of nodes in one network, and each node connects to some other network nodes. When two nodes want to communicate where there is no direct path between them, data from one node to another node can be forwarded through other nodes in the network, thus any two nodes may exist multiple reachable paths. The source node can encode and split the transmitting data packet into many parts and forward these data to the destination node through many routes. The target node can assemble and decode the receiving data, and finally restore the source data. This process is just like the water flow through the porous material to “seepage”, each trickle maybe little, but many trickles assemble together to a complete data stream. Every path can be thought of as a small stream, “Although the trickles are little, but large amount of streams become a torrent”. Finally, the destination node will completely receive and restore the correct transmission source data. Based on this idea, a new framework is constructed and its routing method is proposed in the present invention. The networking is flexible, and its data transmissions are convenient, reliable, and also easy to maintain.

The new network structure is different from the traditional Internet structure. Traditional Internet network lays out a large number of Internet gateways and routers, and network nodes communicate through gateways and routers. In the new network of the present invention, the devices are usually very small, and interconnected over wireless communications. Therefore, both the power consumption and processing ability of the nodes are restricted. Moreover, the network dimension may vary dynamically. In addition, in many applications, the requirements of communication reliability, accuracy and safety of network nodes are high, but the validity of the data transmission, real-time and other requirements may be lower to some extent in this new network architecture. Ubiquitous, heterogeneous and flexible are the typical characteristics of this new architecture of the present invention. In most cases, it is difficult to layout the network gateway and routing equipment in such a network.

In the new network architecture of the present invention, it is costly to use the traditional Internet protocol. First of all, the bandwidth of the network is limited and its data packet size is usually small, while the TCP/IP (transmission control protocol and Internet protocol) protocol and its ARQ (Automatic Repeat reQuest) mechanism consume a lot of extra bandwidth. Moreover, TCP/IP protocol requires a large number of gateways and routers, which increases the complexity of the network structure, resulting in high cost in network deployment and maintenance.

Ad hoc network works well without any gateways and special routers. C. K.-K Toh introduces the network architecture and networking method of wireless Ad Hoc in his book “Ad Hoc Mobile Wireless Networks: Protocols and Systems” published by Prentice Hall, ISBN: 0130078174. G. Jayakumar and G. Gopinath (Journal of Mobile Communication, Year 2008, Volume 2, Issue 1, Page No. 18-26) summarize all the various routing protocols of Ad Hoc. However, in Ad hoc networks, each node must be informed of the complete structure of the entire network to calculate its routing tables. As a result, a large amount of information needs to be broadcasted among the network nodes to maintain the effective routing. Any change in the network structure, as nodes' joining in or departure, may generate significant overhead. Furthermore, to manage and operate a large routing table, a node requires rather high level of storing and processing capability.

### SUMMARY OF THE INVENTION

The purpose of the present invention is to overcome the shortcomings of existing networks and technologies, and hence we propose a new network architecture and its percolation data transmission method. The present invention is achieved through the following technical solutions.

In the new network architecture of the present invention, we define each device in the network as a node, and each node connects with one or more other nodes in the network. We define these two nodes as close neighbors when one node and other nodes have direct connections without forwarding, thus each node and one or more other nodes are close-neighbors. We also define the direct connection relationship between one and one of its close-neighbors as a link. When arbitrary two nodes are not close-neighbor relations, these two nodes can be connected through a limited times' transfer (or reroute). There exists a relationship between arbitrary two nodes through limited number of forwarding, and we define the set of all the middle nodes and links as one route or more routes between these two nodes.

If the route is one-way, we define it an one-way route; if the route is two-way, we define it a two-way route. When the number of close-neighbors is so large that the close-neighbor number is far more than the average close-neighbor number of network nodes, this node is defined as the “star node”.

In the new network architecture of the present invention, each node connects with its close-neighbors. From the view of the whole network, when there are a large number of nodes, each node connects with several nodes randomly and constitutes a “small world model”. According to the theory of six degrees of separation, in such a network, arbitrary two nodes can communicate with very high probability through limited times' forwarding. Thus, if any node wants to transmit data to another node, it is only needed for it to transfer data to the “most possible” nodes or close-neighbors which can forward its data packets to the target node. The accepted close-neighbors will forward the data packets according to the same rule. In this method, one or several routes may be established between arbitrary two nodes.

In the new network architecture of the present invention, there exists routing information in each node itself, and the routing information in each node contains:
1) Number of close-neighbors, i.e. the number of nodes for current node to connect directly without forwarding via close-neighbors.
2) Names of close-neighbors: those names of close-neighbor can be the global name of nodes, or the local name of the current node which distinguish the close-neighbors according to the location information etc.
3) Addresses of close-neighbors of current node and the measures table containing all the addresses of close-neighbors, wherein the node addresses are the serial numbers to distinguish different nodes which can be the IP address of nodes, the local serial number of nodes in the new network architecture of the present invention or addresses of other nodes.
4) Measures of current node that can access all the other nodes through its close-neighbors.

If the current node wants to connect with another node, it may go through only one forwarding through close-neighbors, or two or more times of forwarding through other parts of close-neighbors, otherwise it cannot get to the destination node through another parts of close-neighbors. The measure value of specific target node is determined by the difficulty degree of accessing specific target node accessed by specific close-neighbors of current node. The larger the number of paths that source node connects with the destination node through those specific close-neighbors, the larger this measure value is. For the unknown target node of the current node, it sets the initialization value to zero when the current node participates in the path choosing process.
5) Bandwidth of direct routings between current node and all its close-neighbors.
6) Bandwidth of all nodes which are accessed by close-neighbors of current node.

This list enumerates the history data bandwidth of the path from one node to another node in the network. For the unknown target node of the current node, it sets its bandwidth value to a preset minimum value.

In the new network architecture of the present invention, the routing information table of an arbitrary node C are shown in Table I, where there exists N close-neighbors of C, they are L₁, L₂, . . . , L_{N}, the other nodes (besides the close-neighbors of C) are D₁, D₂, . . . , D_{L}. M_{C}_{_{—}}_{L}_{_{i—}}_{D}_{ₖ} is the measure of D_{K} accessed by C through close-neighbor Lᵢ, which are correlated with relations of network nodes and data rate of current link. R₁, R₂, . . . , R_{N} are the bandwidth of direct routings between C and all its close-neighbors. If there are more paths which can link C to Dₖ, (six transfers at most), the higher data link rates can be achieved.

TABLE I
ROUTING INFORMATION TABLE OF NETWORK NODES

| | |
|---|---|
| Number of close-neighbors | N |
| Names of close-neighbors | L_{1,} L_{2, . . . ,} L_{N} |
| Addresses of close-neighbors | A_{1,} A_{2, . . . ,} A_{N} |
| Bandwidth of the direct links from | R_{1,} R_{2, . . . ,} R_{N} |
| current node to close-neighbors | |
| Measures from current node to the | M_{C}_{_{—}}_{L}_{_{1 —}}_{D}_{₁} |
| node D₁ via the close neighbors | . . . |
| | M_{C}_{_{—}}_{L}_{_{N —}}_{D}_{₁} |
| . . . | |
| Measures from current node to the | M_{C}_{_{—}}_{L}_{_{1 —}}_{D}_{_{L}} |
| node D_{L} via the close neighbors | . . . |
| | M_{C}_{_{—}}_{L}_{_{N —}}_{D}_{_{L}} |
| Bandwidth from current node to the | R_{C}_{_{—}}_{L}_{_{1 —}}_{D}_{₁} |
| node D₁ via the close neighbors | . . . |
| | R_{C}_{_{—}}_{L}_{_{N —}}_{D}_{₁} |
| . . . | |
| Bandwidth from current node to the | R_{C}_{_{—}}_{L}_{_{1 —}}_{D}_{_{L}} |
| node D_{L} via the close neighbors | . . . |
| | R_{C}_{_{—}}_{L}_{_{N —}}_{D}_{_{L}} |

After the networking procedure, the network is needed to be initialized or each node to be initialized in the network. The initialization procedure is as follow:

First, send the query signals of close-neighbors and send back the response signal when receiving those nodes' query signals. The receiving nodes should establish number of close-neighbors, names and addresses of the close-neighbors, and also the routing bandwidth between the current node and close-neighbors according to the query and responding signals.

Second, set all the measures of the current node accessing the non-neighbor nodes via its close-neighbors the value 0. Set all the bandwidth of the current node accessing the non-neighbors via its close-neighbors to preset minimum values. For those unknown destination nodes of the current node, preset memories are reserved for its measures and bandwidth.

The present invention relates to a percolation data transmission method of the new network architecture. According to the different network links, the data transmission methods are divided into one-way data transmission method and two-way data transmission method. When the network link is a two-way link, then the link adopts the two-way data transmission method, and the two-way data transmission method contains routing process and data transmission process. Routing process is the decision process of data transmission. When the network link is a one-way link, then it adopts the one-way data transmission method.

1) The two-way data transmission method contains the routing procedure and data transmission process. When the network link is a two-way link, in order to reduce communication overhead, it is necessary to prevent part of the percolation paths unable to reach the receiving node. The sending packets of monitoring test data before sending the data is called the probe. To prevent flooding, the maximum forwarding number is restricted to Y during the routing process. Meanwhile, for the balancing of resources' usage, we limit the total number of routes between two nodes to a maximum of X, and so we limit the number of maximum paths to X.

The two-way routing procedure comprises:

Step 1: Initialize the network first, i.e. initialize all nodes in the network.

Step 2: The source node sends probe packets to its close-neighbors. Those probe packets contain the address information of source, target nodes and the forwarding number counter. Y positions of addresses of forwarding nodes are preset and the forwarding counter number is set to zero.

Step 3: After the close-neighbors receive the probe packet, if the current node is the destination node, go to step 4; Otherwise, check the value of forwarding number counter. There are two cases when the value is less than Y:

First, if there exists a non-close loop close-neighbor node, add one to the probe packet counter. The address of current forwarding node is written into probe packet and the updated probe packet will forward the probe information to the close-neighbors of this node reaching the destination node in the largest measure of neighbors, then repeat step 3 until the aforementioned forwarding close-neighbor node is the destination node, as set forth above, then go to step 4.

Second, if there doesn't exist a non-close loop for close-neighbor node, as set forth above, we drop this probe data packet and finish this routing procedure.

Step 4: The destination node uses “path reservation rule” to calculate and reserve information of maximum X paths according to the probe packets which are sent from the transmitting node to the destination node. The aforementioned path reservation rule indicates that when the path number of the source node to destination node in those probe packets are greater than X, the shortest paths or the largest X-throughput paths are retained and reserved.

Step 5: The destination node will feedback the data packets composed of the selected path information to the transmitter node through the selected paths. When the feedback information passes through the intermediate nodes, each intermediate node updates the routing information.

Thus, the routing procedure is complete. After routing operation, we can transfer data through the selected routes. Data are transferred as follows:

Step 1: The source node encodes the data to be sent and sends the encoded data into the corresponding path after distributing the load according to the throughput capacity proportion of the various paths.

Step 2: After the intermediate nodes receive those data packets, if the current node is the destination node, go to step 3; otherwise, the encoded data are forwarded to the next close-neighbor node of the current route, until reaching the final destination node.

Step 3: The destination node assembles and decodes the encoded data received from the various paths and sends feedback ACK (acknowledge) back to the transmitting node after successful decoding.

Step 4: The source node receives the ACK from the destination node and goes to Step 1 to encode and transmit the next set of data.

The encoding methods of the aforementioned source node in Step 1 of above two-way data transmission process could be LT (Luby Transform) code, Raptor code, etc. of the fountain codes, as set forth above.

2) In the initialization phase of the one-way data transmission method, a node transmits the initialization information.

But due to the limitation of processing and storage capability of network nodes, at other working phases of network node, the network link is one-way and the receiver cannot send feedback information back to transmitter. A one-way communication is needed and cannot use probe packet to select routing paths and communicate. In a one-way data transmission method, the data packet is delivered to close-neighbors to cooperate forwarding.

For the reasons of uncertainty of data packets, each node forwards those packets to its close-neighbors, and parts of the data packets may be lost in half way. So the transmit node needs to encode the original data, produce and send the redundant data packets, ensure that the aforementioned destination node can correctly recover source data below the probability of P0, and the value of which is selected according to the actual transfer data type. Meanwhile, for the balance of resources' usage, we limit the forwarding number to maximum Y and limit the maximum number of routes between any two nodes to X, as set forth above.

The one-way data transmission process comprises:

Step 1: Initialize the network, i.e. initialize each node.

Step 2: The source node encodes the data file to be transmitted. Select several close-neighbors according to the measures between the current node and its close-neighbors and assign the loads to the paths proportional to their throughput capacity in order to ensure that receiver's probability of recovering source data is above preset P0. The source node encodes the data file to be sent and feeds the encoded packets to the selected paths according to their load capacities assigned. The packet head of data packet contains the aforementioned source address, destination address and a hop counter. Y positions are reserved in the probe for the relay nodes and the counter number is set to zero.

Step 3: After the close-neighbors receive the probe packets, if the node is the destination node, go to step 4; Otherwise, the current node will check the hop counter and switch to the following two cases if the hop counter is less than Y:

Case 1: If there doesn't exist a close-loop close-neighbor node in this selecting path, increase the hop counter by one and the address of the current node is written into the probe packet. Forward the renewed probe packet to a close-neighbor of the maximum measures. Repeat step 3 until the destination is reached, then go to step 4.

Case 2: If none of any close-neighbor forms a non-closed path, we drop this probe data packet and terminate this routing procedure.

Step 4: The destination node assembles and decodes the data packets from all paths, and after successful decoding, it will terminate receiving the data packet of each path. Calculates and selects maximum X distinct or parallel paths for routing. The rule of selecting paths may be based on the least hops and the maximum throughput, etc. One may use fountain codes, such as LT and Raptor codes in the source data encoding of Step 1 of the aforementioned one-way data transmission process.

A two-way data transmission routing method comprises:

When the network dimension is large and if a node is randomly connected to several other nodes in the network, this kind of network can be modeled as a small world network as long as a node is randomly connected to several other nodes. In such a network, any node can establish communication links with other nodes through few relays (generally no more than six) with a very high probability. In the routing process, each node in the network participates the routing process and each node needn't to be informed of the complete structure of the entire network, and it only need to know the routing selections of its own close-neighbors. There exists many parallel routers and they transmit data through encoding and each path transmits part of all the data between any two nodes in the network. It is only needed for the aforementioned receiver to receive enough source data packets that could be decoded and the lost of partial data packets are impregnable to the recovering of receiver data stream. This process is just like the water flow through the porous material to “seepage”, where each trickle may be little, but many trickles assemble together to a complete data stream. In the aforementioned routing process, part of the probe packets transmitting from the aforementioned source node can get to the aforementioned target node to form a route.

The other part of the probe packets, as set forth above, will terminate because the aforementioned hop counter exceeds the Y, which means there are no useful forwarding links, etc.

The path which each independent probe packet flows from the transmitting node to terminating node is called a seepage route of probe packet. The route containing those selected seepage paths that connect the source node and the target node is called “route based on percolation”. The kernel of the new network architecture of the present invention is based on percolation and its seepage routing technology. The node can easily receive the information sent from its neighbors, but it's hard to communicate with those faraway nodes. Since each node connects with its close-neighbors, by observing from the whole network, when there are many nodes, each node randomly connects with several nodes in the network to form a small world model. According to the six degrees of separation principle, any node can reach everywhere in finite steps of relaying with a very high probability. So, if any node wants to send data packets to another node, it only needs to send data packet to “the most possible” close-neighbors through its neighbors. The commissioned close-neighbors will forward probe packets according to the same rule. If the transmitter dispatches the data packet into many parts and forwards these data to many close-neighbors, as set forth above, each commissioned close-neighbor will forward several parts. So many paths can be established between the transmitter and the target nodes, as set forth above. This information transmission method is based on percolation and its networking needn't set up the routers. The probability forwarding is based on the aforementioned close-neighbors and has several characteristics such as quick response, low cost and low power consumption. The network can operate at very low cost of maintenance or even without maintenance.

The data transmission theory in the aforementioned two-way data transmission routing method comprises:

During the data transmission progress, if the transmitter node dispatches the sending data into many parts and hands these data to many close-neighbors, each commissioned close-neighbor will forward several parts, so many paths can be established between the transmitter and the target nodes. If all these data are transmitted successfully to the destination node and the destination node knows all the order of each part of data, the destination node will recover the source data. In an actual network, the routers which are based on probability forwarding, part of those data packets can not be sent to the destination node, and due to reasons of router halt, link error or loss of probe packets, all these conditions can cause the destination node unable to recover the source data. In the aforementioned steps of data transmission, the transmitter node encodes and dispatches the data into many parts, so if parts of packets in the network are lost, only the aforementioned destination node receives enough data packets. We will recover the aforementioned source data through decoding enough receiving data packets and need not use the feedback and retransmit those data packets, as set forth above. The whole process which contains dispatching data of the source node, forwarding parts of data through many paths, assembling and decoding source data from all the paths of the aforementioned destination node, is called the percolation process. The protocols based on percolation principle are called percolation protocols. High efficient data departure (or dispatching) and retrieving can be accomplished by fountain codes such as LT codes and Raptor codes widely and successfully used in the field.

The data transmission theory in the aforementioned one-way data transmission routing method comprises:

When the network dimension is large and if a node is randomly connected to several nodes in the network, this network can be modeled as a small world network as long as a node is randomly connected to several other nodes. In such a network, any node can establish communication links with other nodes through few steps of relaying with a very high probability. In this kind of data transmission, the transmitted source data forwards the encoded data according to the small-world model. Each data packet routes from the transmitter node to the destination node based on percolation path and the data packet which flows on the percolation route is called percolation data packet. The aforementioned percolation route connects with the destination node, as set forth above, at a definite probability, and parts of the aforementioned percolation paths can not reach the aforementioned destination node, and so the percolation data packets are dropped in the network. Since the transmitted data are encoded by the aforementioned source node, any data packets lost in the aforementioned percolation paths will not affect the data receiving of receiver node. If the redundancy of transmitter is appropriately selected, the probability of exactly receiving source data can be ensured. This method does not need feedback channel completely and it is suitable for a low-cost, low-speed data transmission network.

### ADVANTAGES OF THE PRESENT INVENTION

The new network architecture of the present invention and its data transmission method based on percolation have the following advantages:
1) The networking and maintenance cost of the new network architecture of the present invention is very low. It needn't set up gateways and routers in the network, and each node can be the aforementioned source node or destination node, at the same time, it has routing function. Each node records only the information of neighboring nodes and measures according to the setting probability, as set forth above.
2) The present invention lowers the storage and processing capabilities of each network node. When the aforementioned nodes increase, move or depart, the aforementioned close-neighbors will renew the probe packets according to these updated information without affecting other nodes in the network to achieve the network's “self-management”, “self-maintenance”, and unattended operation and maintenance of the network.
3) The source node encodes and transmits data, and when the destination node receives enough data packets, it will recover the data from which the source node transmits. The conditions that some parts of the probe packets get lost and some parts of the routers get halt will not cause the receiving data unable to be recovered. The aforementioned source node does not need to use the feedback and retransmit those data packets to ensure receiving correctly. The network data transfer scheme is highly reliable. It doesn't need feedback and retransmission of data. Meanwhile, the aforementioned method of the present invention lowers the network bandwidth overhead and reduces the complexity of network protocol implementation.
4) The present invention ensures the safety of the transmitting network data. After the aforementioned source data are encoded and split, any other intermediate nodes (besides the source and destination node) only have parts of the coding groups of the source data, even if the intermediate nodes master the coding method completely, they may not recover and steal the source data because the quantities of obtained data are insufficient physically to decode the source data. For the reasons of the data being encoded and the coding data being verified, those data packets which cannot satisfy the verified equation are dropped. If the aforementioned encoding method is reasonable, it will be effective to prevent the illegal nodes intermingled into the network.
5) The disclosed new network architecture has a strong expansibility and has a high-speed communication capability. Because the protocols of the aforementioned percolation network use many parallel routers to transmit data, it only needs to build more parallel routers to obtain high speed data communication. In order to further improve the throughputs of the network data in the present invention, we may set “star” nodes in the network which is based on percolation. The “star” nodes have many relations and high processing capabilities, and it can improve the data throughput ability of the network protocol to improve the overall throughput of the backbone network.

The requirements of storage and processing abilities of nodes in the network of the present invention are low. The difference between the present invention and the Ad hoc network is that each node in Ad hoc network must store the complete information of all the network nodes, while in the network routing method of the present invention, the data table of one node contains only parts of the network nodes. It may contain the complete information of all the nodes, but depend on the storage and process abilities of each node and history routing information, etc. If the storage capability of one node is low, it contains the node information of the aforementioned close-neighbors, but it doesn't contain data of other nodes.

In other aspects, the present invention provides two examples having features and advantages corresponding to those contents discussed as set forth above.

All these and other introductions of the present invention will become much clear when the drawings as well as the detailed descriptions are taken into consideration.

### BRIEF DESCRIPTION OF THE DRAWINGS

For the full understanding of the nature of the present invention, reference should be made to the following detailed descriptions with the accompanying drawings in which:

FIG. 1 shows a block diagram of the network architecture of the present invention.

FIG. 2 illustrates the architecture of the network of the first scenario and the block diagram of two-way data transmission method to obtain various routing information.

FIG. 3 illustrates the architecture of the network of the second scenario and the block diagram of data transmission progress of one-way data transmission method.

Like reference numerals refer to like parts throughout the several views of the drawings.

### DESCRIPTION OF THE PREFERRED EMBODIMENT

The present invention will be described more fully with references to the accompanying drawings, in which two examples of the embodiments of the present invention are shown. Indeed, the present invention may be embodied in many different forms and should not be construed as limited to the embodiments set forth herein. Rather, these embodiments are provided by way of example so that this disclosure will satisfy applicable legal requirements. Like numbers refer to like elements throughout.

The first example of the embodiments of the present invention is as follows:

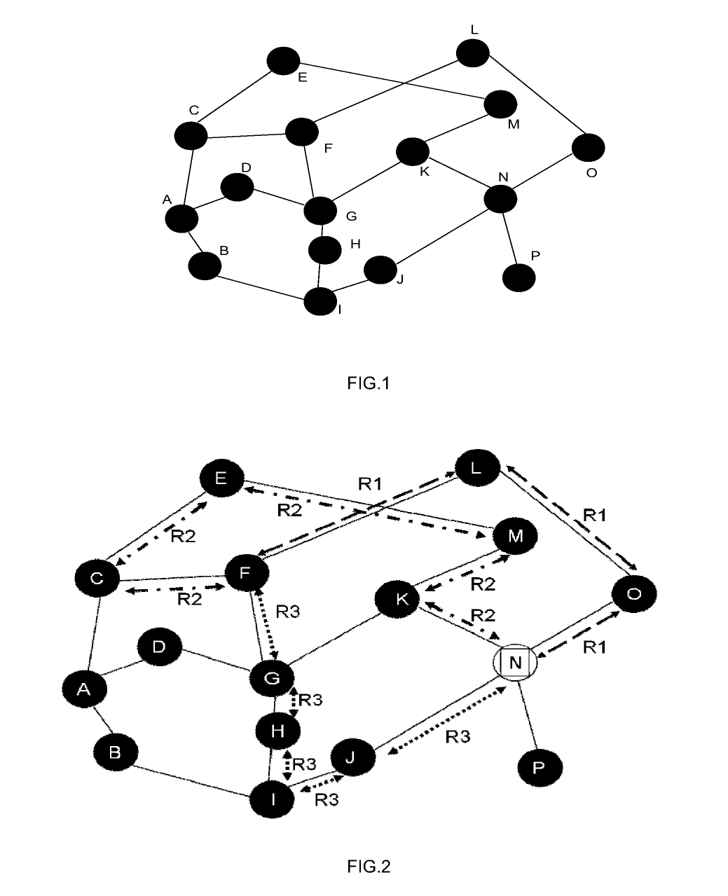

The network architecture of the present invention contains A, B, C, . . . M, N, O, altogether fifteen nodes. The close-relationship of this network is shown in FIG. 2. Each node in this network has several aforementioned close-neighbors, for example, node F has three close-neighbors and node P has one close-neighbor node which means that when P receives probe packets or data packets from other nodes not belonging to the destination node P, they will be dropped by node P, as set forth above. Every two nodes in the network may communicate directly or connect through few forwarding, for example, there are no direct path between node F and node N, but there exists multiple paths between them, such as F-G-K-N or F-C-E-M-N.

The network initialization process is as follows:

1) A node sends the query signal of close-neighbors. Any node which receives this query signal sends back a reply. The nodes involved in these query and reply signals establish and renew their information table, including the following fields: number of close-neighbors, Names and addresses of close-neighbors, bandwidth of the direct links from the current node to close-neighbor, etc, as set forth above.
2) Set all the measures from current node to other nodes via close neighbors to 0. Set all the bandwidth from current node to other nodes via close-neighbors to a pre-determined minimum values. For those unknown destination nodes to the current node, reserve adequate memory for the measures and bandwidth, as set forth above.

The links in the network of the present invention are two-way routes. If node F wants to communicate with node N, the limited maximum forwarding times is 6, and the limited maximum routes are 5. The percolation data transmission method of the present invention contains the routing procedure and data transmission process, in which the routing procedure comprises:

Step 1: Initialize the network, i.e. initialize each node.

Step 2: The source node F sends probe packets to its close-neighbors. Those probe packets contain the address information of source, target nodes and the forwarding number counter. Six positions of address of forwarding nodes are preset and the forwarding counter number is set to zero.

Step 3: After the close-neighbors receive the probe packet, if the current node is the destination node, go to step 4; Otherwise, check the value of forwarding number counter. There are two cases when the value is less than 6:

First, if there exists a non-close loop close-neighbor node, add one to the probe packet counter and the address of current forwarding node is written into probe packet, and the updated probe packet will forward the probe information to the close-neighbors of this node reaching the destination node in the largest measure of neighbors, then repeat step 3 until the forwarding close-neighbor node is the destination node, then go to step 4.

Second, if there doesn't exist a non-close loop close-neighbor node, we drop this probe data packet and finish this routing procedure, as set forth above.

Step 4: The destination node uses “path reservation rule” to calculate and reserve maximum 5 paths' information according to the probe packets sent from transmitting node to the destination node, as set forth above.

Step 5: The destination node N will feedback the data packets composed of the selected path information to the transmitter node through the selected paths. When the feedback information passes through the intermediate nodes, each intermediate node updates the routing information.

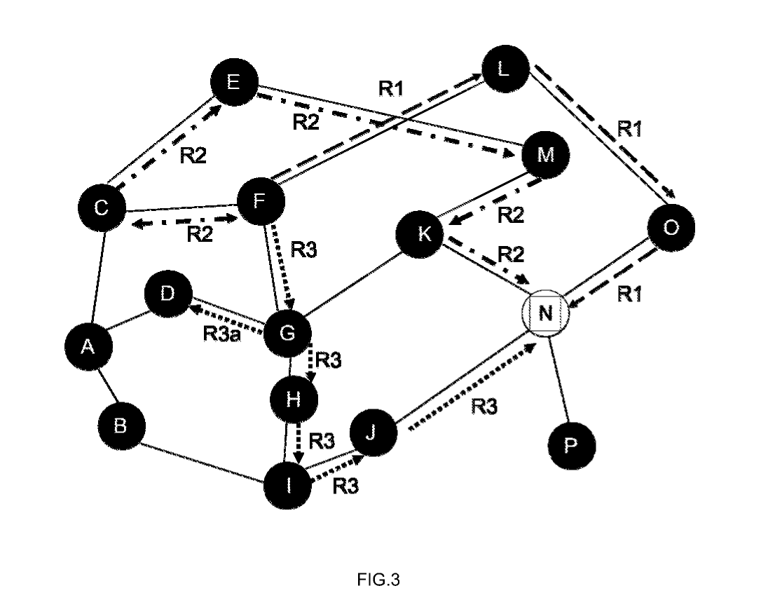

Thus, the routing procedure is complete. Through above steps, three routes are selected which are R1, R2 and R3 as shown in FIG. 3. After routing, data can be transferred through the selected routes.

The aforementioned Data are transferred as follows:

Step 1: The source node F encodes the data to be sent using LT fountain code and sends the encoded data into the first intermediate node of every path after distributing the load according to the throughput capacity proportion of the various paths.

Step 2: After the intermediate nodes receive those data packets, if the current node is the destination node, then go to step 3; otherwise, the encoded data are forwarded to the next close-neighbor node of the current route, until reaching the final destination node.

Step 3: The destination node N assembles and decodes the encoded data received from the various paths and sends feedback ACK (acknowledge) back to the transmitter node after decoding successfully.

Step 4: The source node receives the ACK from the destination node and goes to Step 1 to encode and transmit the next set of data.

For the encoding method of source node in the aforementioned two-way data transmission process, Step 1 could be LT code, Raptor code, etc of the fountain codes.

The second example of the embodiments of the present invention is as follows:

The new network architecture of the present invention contains A, B, C, . . . M, N, O, altogether fifteen nodes. The close-relationship of the network of the present invention is shown in FIG. 3, and each link in the network is a one-way route. The nodes pointed by arrows receive the data packets from arrow starting nodes directly, for example, there are three links starting from node F and ending at nodes G, C and L, in which node F can transmit data to node G directly, but node G cannot send data to F directly, i.e. node G is a close-neighbor of node F, but node F is not a close-neighbor of node G.

The initialization process of each node in the network of the present invention comprises:

1) A node sends the query signal of close-neighbors. Any node which receives this query signal sends back a reply. The nodes involved in these query and reply signals establish and renew their information table, including the following fields: number of close-neighbors, Names and addresses of close-neighbors, bandwidth of the direct links from the current node to close-neighbor, etc, as set forth above.
2) Set all the measures from current node to other nodes via close neighbors to 0. Set all the bandwidth from current node to other nodes via close-neighbors to a pre-determined minimum values. For those unknown destination nodes to the current node, reserve adequate memory for the measures and bandwidth.

In the new network of the present invention, if the network links are one-way links, and if node F wants to communicate with node N, the forwarding number is limited to maximum 6 and the maximum number of routes is limited to 5. The percolation procedure comprises:

Step 1: Initialize the network, i.e. initialize each node.

Step 2: The source node F encodes the data file to be transmitted using Raptor fountain coding. Select several close-neighbors according to the measures between current node and its close-neighbors and assign the loads to the paths proportional to their throughput capacity in order to ensure receiver's probability of recovering source data above preset P0. The source node encodes the data file to be transmitted and feeds the encoded packets to the selected paths according to their load capacity assigned. The packet head of data packet contains the source address, destination address and a hop counter. Six positions are reserved in the probe for the relay nodes and the counter number is set to zero.

Step 3: After the close-neighbors receiving the probe packets, if the current node is the destination node, then go to step 4; Otherwise, the current node will check the hop counter and switch to the following two cases if the hop counter is less than 6:

Case 1: If there doesn't exist a close-loop close-neighbor node in this selecting path, increase the hop counter by one and the address of the current node is written into the probe head. Forward the renewed probe head and data packet to at least one open-loop close-neighbor.

Case 2: If none of any close-neighbor forms a non-closed path, we drop this probe data packet and terminate this routing procedure, as set forth above.

Step 4: The destination node N assembles and decodes every data packet from all paths, and after successful decoding, it will terminate receiving this data packet of each path.

The aforementioned source data will transmit based on percolation in the network of the present invention after the aforementioned fountain coding. The data packets belonging to R1, R2 and R3 paths arrive at the destination node as shown in FIG. 3. After the data packets of R3a branch (which is F→G→D) arriving at node D, D node hasn't any close-neighbor node, so the data packets are dropped and the routing branch is terminated.

The method of the present invention is not meant to be limited to the aforementioned experiment, and the subsequent specific description utilization and explanation of certain characteristics previously recited as being characteristics of this experiment are not intended to be limited to such techniques.

Many modifications and other embodiments of the present invention set forth herein will come to mind to one skilled in the art to which the present invention pertain having the benefit of the teachings presented in the foregoing descriptions and the associated drawings. Therefore, it is to be understood that the present invention is not to be limited to the specific examples of the embodiments disclosed and that modifications and other embodiments are intended to be included within the scope of the appended claims. Although specific terms are employed herein, they are used in a generic and descriptive sense only and not for purposes of limitation.

1. A method of percolation networking architecture for data transmission and routing, wherein said method comprising:
a) Each one device defined as a network node and each said node connecting with one or more other said nodes in the network,
b) When one said node connecting with another said node directly without other forwarding connections, these two said nodes defined as close-neighbors,
c) Defining direct connect-relations between one said node and its said close-neighbors as links,
d) Defining a relationship with middle said nodes and said links as one route wherein these said nodes can connect through limited number of said forwarding when arbitrarily two said nodes in the network don't have said close-neighbor relations, and
e) Defining one-way route if said route is one-way and defining two-way route if said route is two-way.

2. The method as recited in claim 1 wherein every said node in the network has routing information and said routing information comprising:
a) Close-neighbor number of current node or number of direct accessible nodes without forwarding,
b) Names of said close-neighbors,
c) Addresses of said close-neighbors,
d) Measure value list of all said nodes which are accessed by said close-neighbors of said current node,
e) Said measure value of specific target node determined by the difficulty degree of accessing said specific target node accessed by specific said close-neighbors of said current node,
f) Bandwidth from said current node to its said close-neighbors, and
g) Bandwidth from said current node to a faraway node via its said close-neighbors.

3. The method as recited in claim 1 wherein the initialization of each said node in the network comprising:
a) A node sending a query signal of said close-neighbors,
b) Any said node receiving said query signal sends back a reply,
c) Said nodes involved in said query and reply signals establish and renew their information table, including said number of said close-neighbors, said names and addresses of said close-neighbors, said bandwidth of direct links from said current node to said close-neighbors, etc,
d) Setting all measures from said current node to other said nodes via said close neighbors to 0,
e) Setting all said bandwidth from said current node to other said nodes via said close-neighbors to a pre-determined minimum values, and
f) For those unknown destination nodes to said current node, reserving adequate memory positions for said measures and said bandwidth.

4. The method as recited in claim 1 wherein, when said links in said networking architecture are two-way links, limiting said forwarding number of every said node to maximum Y, and limiting said routes number between every two said nodes to maximum X, said data transmitting process comprising:
Step 1: First initializing every said node in the network,
Step 2: A source node sending probe packets to its said close-neighbors, said probe packet containing address information of said source node, said address information of a target node and said forwarding number counter and said Y location addresses of forwarding nodes being reserved, wherein said forwarding number counter is set to zero,
Step 3: After said close-neighbors receiving said probe packets, if said current node is said target node, then going to Step 4, or said current node will have said forwarding number counter value of an intermediate node, and if said value is below Y, said method further comprising two conditions:
Case 1: If there existing close-loop said close-neighbors of said current node, adding one to said probe packet number counter, writing the address of said current node to said probe packet and forwarding the renewed said probe packet to said close-neighbors having the maximum said measure value of all said close-neighbors, and repeating Step 3 until said forwarding close-neighbor node is said target node, then going to Step 4, or
Case 2: If there not existing close-loop said close-neighbors of said current node, then dropping said probe packet and finishing said routing process,
Step 4: Utilizing path reservation rule to calculate and reserve maxim X paths' parallel path information for said destination node with said path information in every said probe packet from said source node to said destination node, wherein said path reservation rule indicating when said path number of said source node to said destination node in said probe packet being greater than said X, the shortest paths, or the largest said X-throughput paths being retained and reserved, and
Step 5: Said target node assembling selected routing information to data packet, and sending feedback to transmitter through every paths' information, and when said feedback information passing middle nodes, every said middle node adding a unit measure value to other nodes of said current node's routing list, and renewing its own other routing information, and when said routing process finished, said source node using said selected route to perform data transmission process.

5. The method as recited in claim 4 wherein said data transmission process further comprising:
Step 1: Said source node encoding transmitting data and distributing loads according to the throughput capacity proportion of various said routes and sending encoded data to the first middle node of every corresponding said routes,
Step 2: After said middle nodes receiving said data packets, if said current node is said destination node, going to step 3, otherwise, said encoded data being forwarded to the next said close-neighbor node of said current route, until sending to the final said destination node,
Step 3: Said destination node assembling and decoding said encoded data received from various paths, and said destination node sending feedback ACK (acknowledge) back to said transmitter node after successful decoding, and
Step 4: Said source node receiving said ACK sent back from said destination node and going back to above Step 1 to encode and transmit the next set of data.

6. The method as recited in claim 1 wherein, when said links in said network are one-way links, limiting the maximum forwarding number to said Y, and limiting the maximum route number between every two nodes to said X, said data transmitting process comprising:
Step 1: First initializing the network, wherein each said node having its initialized routing information table,
Step 2: Said source node encoding data file to be transmitted and selecting some said close-neighbors according to measures of said current close-neighbors and said target node, assigning loads to said paths proportional to their throughput capacity, feeding said encoded packets to said selected paths according to their load capacity, wherein said data packet being proportional to said throughput capacity to ensure the probability of said receiving node recovering source data above preset P0, and wherein the packet head of said data packet containing address information of said source node and said target node, also containing said forwarding number of counter, reserving said Y address locations of said forwarding nodes and setting said forwarding number counter to zero,
Step 3: After said close-neighbor node receiving said data packets, if said current node being said destination node, going to step 4, otherwise, checking hop counter and switching to following two cases if said hop counter being less than said Y:
Case 1, if there not existing a close-loop of said close-neighbor of said current node, adding one to said forwarding number counter, writing said address information of said current node to said data packet, and forwarding said renewed data packet and data to at least one said close-neighbor of non-close-loop node, or
Case 2, if there not existing a non-close-loop of said close-neighbor, then said current node dropping said receiving data packet, and
Step 4: Said target node assembling and decoding said data from each said path and stopping receiving said data after said decoding procedure being complete, wherein said preset probability P0 of said Step 2 being selected through an actually transmitted data type.

7. The method as recited in claim 4 and 6 wherein said encoding method of said source node for said data transmission process is fountain coding.

8. The method as recited in claim 7 wherein said encoding method of said fountain coding is LT (Luby Transform) code.

9. The method as recited in claim 7 wherein said encoding method of said fountain coding is Raptor code.
